(19) United States
(12) Patent Application Publication
(10) Pub. No.: US 2007/0013963 A1
(43) Pub. Date: Jan. 18, 2007

(54) Image processing apparatus

(75) Inventor: Noriaki Nakamura, Fukushima (JP)

Correspondence Address: RABIN & Berdo, PC, 1101 14TH STREET, NW, SUITE 500, WASHINGTON, DC, 20005, US

(73) Assignee: OKI DATA CORPORATION

(21) Appl. No.: 11/481,836

(22) Filed: Jul. 7, 2006

(30) Foreign Application Priority Data
Jul. 13, 2005 (JP) JP2005-204134

(51) Int. Cl. H04N 1/00

(52) U.S. Cl. 358/403

(57) ABSTRACT

An image processing apparatus having a data converting unit which converts inputted image information into image data which can be outputted by an external output apparatus and an output control unit which outputs the converted image data to the output apparatus, includes: a storing unit which sequentially stores the image data in parallel with the output of the image data from the data converting unit to the output control unit; and an instructing unit which selects a desired one of the plurality of image data sequentially stored in the storing unit and instructs the output control unit to re-output the selected image data. When the re-output is instructed, the output control unit transfers the selected image data to the output apparatus from the storing unit.

### BACKGROUND OF THE INVENTION

1. Field of the Invention

The invention relates to an image processing apparatus and, more particularly, to an image processing apparatus which outputs image data to an image forming apparatus such as a printer or the like.

2. Related Background Art

As image processing apparatuses, there are a document forming apparatus represented by a word processor, an editing apparatus for editing a figure or a photograph image, and the like. According to those image processing apparatuses, document information or image information inputted by using an input apparatus such as pointing device represented by a mouse, keyboard, or the like is converted into image data in a format which can be interpreted by the image forming apparatus such as a printer or the like serving as an output apparatus and the image data is outputted.

In recent years, most of functions of such image processing apparatuses have been realized by each application program (hereinafter, also simply referred to as AP) installed in a personal computer (PC).

As image forming apparatuses, there are a printer, a facsimile apparatus, and the like. They are directly connected to the personal computer in which the foregoing APs have been installed or connected thereto through a network such as LAN (Local Area Network) or the like and used.

There is a case where it is intended that data which has once been sent from the image processing apparatus to the image forming apparatus is outputted again by the image forming apparatus. For example, in the case of the word processor, there is a case where a plurality of print copies of the same document are printed after a short interval, a case where another one or a plurality of print copies of the same document is/are printed after the contents of the outputted document were confirmed, or the like.

In such a case, there is a technique in which before the data is first outputted to the image forming apparatus, information showing whether or not there is a schedule to reprint the same data has preliminarily been set and the reprint is executed (for example, refer to JP-A-2000-177186).

However, according to the foregoing prior art, the information about the necessity of the re-output has to be preliminarily set. In the case where the user forgets to make such a setting, or after the data has once been outputted, it is determined that the re-output is necessary, or the like, the same procedure as that at the first time of the setting (for example, the operations in which the AP is activated again, a target document file is opened, a document range to be outputted is designated in substantially the same manner as that at the first time, and the output is instructed) has to be repeated, so that use efficiency is low.

It is a problem to be solved that the information about the necessity of the re-output has to be preliminarily set and if such a setting is not made, the same operations as those at the first time have to be repeated in order to re-output and the use efficiency is low.

### SUMMARY OF THE INVENTION

It is an object of the invention to provide an image processing apparatus which outputs image data to an image forming apparatus such as a printer or the like at high use efficiency.

According to the present invention, there is provided an image processing apparatus, comprising:

a data converting unit which converts inputted image information into image data which can be outputted by an output apparatus connected to an outside;

an output control unit which outputs the image data converted by the data converting unit to the output apparatus;

a storing unit which sequentially stores the image data in parallel with the output of the image data from the data converting unit to the output control unit; and

an instructing means which selects a desired one of the plurality of image data which have sequentially been stored in the storing unit and instructs the output control unit to re-output the selected image data,

wherein the output control unit, when is instructed to re-output by the instructing means, transfers the image data selected by the instructing means to the output apparatus from the storing unit.

Moreover, the image processing apparatus may further comprise an image information forming unit which forms the image information, and wherein the data converting unit converts the image information formed by the image information forming unit.

Moreover, the image processing apparatus may further comprise an image reading unit which reads the image information from a sheet of original, and wherein the data converting unit converts the image information read by the image reading unit.

Moreover, the image processing apparatus may further comprise a communicating unit which receives the image information from an external transmitting apparatus, and wherein the data converting unit converts the image information received by the communicating unit.

Moreover, the image processing apparatus may further comprise a timer means which measures a holding time of the image data stored in the storing unit and a deleting means which deletes the image data stored in the storing unit, wherein the storing unit stores the image data which is sequentially stored and time information indicative of time when the image data has been stored in correspondence to each other, and when the holding time measured by the timer means exceeds a predetermined period, the deleting means deletes the corresponding image data from the storing unit.

Moreover, the image processing apparatus may further comprise a counter means which counts the number of image data stored in the storing unit, and wherein when the number of image data counted by the counter means exceeds a predetermined number, the deleting means deletes the image data from the storing unit. In the case, the deleting means may delete the image data in order from the image data of a longer holding period.

Moreover, in the image processing apparatus, the output control unit may further have a holding job list storing unit which stores identification information of the image data stored in the storing unit and the image data in correspondence to each other; a display control unit which displays the identification information stored in the holding job list storing unit to a display apparatus; and a user input unit which selects a job to be re-outputted on the basis of the identification information displayed on the display apparatus.

Moreover, the image processing apparatus may further comprise a data transfer destination selecting unit which selects an output destination of the image data.

According to the invention, the image processing apparatus comprises: the storing unit which sequentially stores the image data in parallel with the output of the image data from the data converting unit to the output control unit; and the instructing means which selects a desired one of a plurality of image data which have sequentially been stored in the storing unit and instructs the output control unit to re-output the selected image data, wherein when the re-output is instructed by the instructing means, the output control unit transfers the image data selected by the instructing means to the output apparatus from the storing unit. Therefore, there are such advantages that there is no need to preliminarily set the information about the necessity of the re-output, there is no need to repeat the same operations as those at the first time in the case of re-outputting, and the use efficiency is high.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a construction of an image processing apparatus according to the invention;

FIG. 2 is a block diagram showing a construction of a reprint control apparatus;

FIG. 3 is a diagram showing a construction of a reprint control apparatus setting display screen;

FIG. 4 is a diagram showing a construction of a termination selecting display screen;

FIG. 5 is a diagram showing a construction of a holding job list;

FIG. 6 is a diagram showing a construction of a printer driver list;

FIG. 7 is a diagram showing a construction of a reprint selecting display screen;

FIG. 8 is a diagram showing a construction of a job selection display screen;

FIG. 9 is a diagram showing a construction of a setting change display screen;

FIG. 10 is a diagram showing a construction of a work area;

FIG. 11 is a flowchart showing a main processing routine;

FIG. 12 is a flowchart showing a reprinting process;

FIG. 13 is a flowchart showing a setting change reprinting process;

FIG. 14 is a flowchart showing a terminating process;

FIG. 15 is a flowchart showing a print control apparatus setting process;

FIG. 16 is a diagram showing a construction of an output destination selecting display screen;

FIG. 17 is a block diagram showing a modification of the image processing apparatus according to the invention; and

FIG. 18 is a block diagram showing a construction of a storage managing unit and a re-output unit.

### DETAILED DESCRIPTION OF THE PREFERRED EMBODIMENTS

The object which enables the re-output to be performed without previously designating the re-output is realized with respect to the case where document data formed by a word processor is printed by a printer.

### Embodiment 1

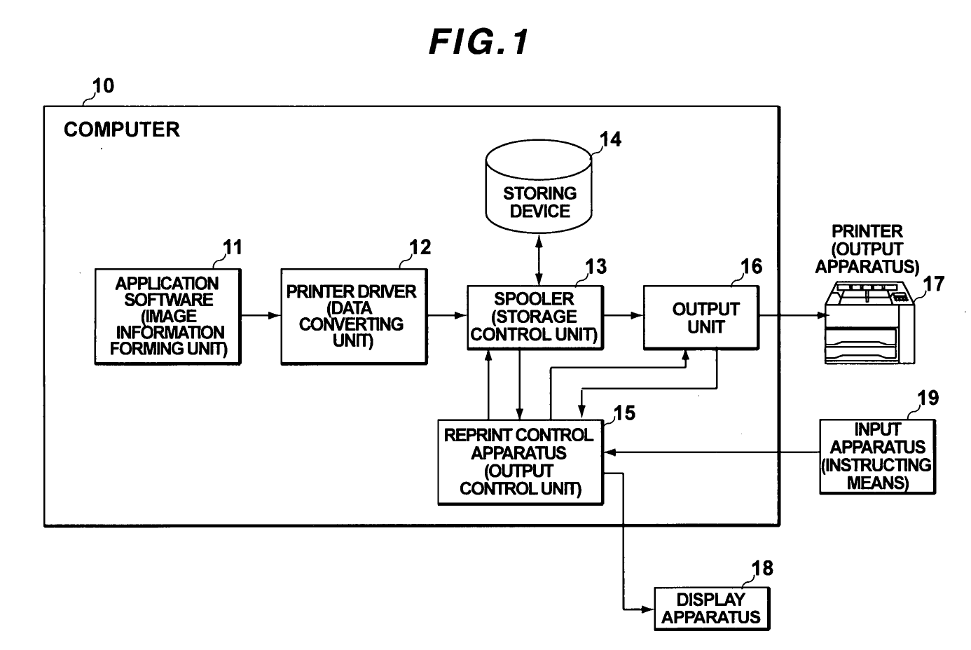

FIG. 1 is a block diagram showing a construction of an image processing apparatus according to the invention.

A system in FIG. 1 is constructed by a computer 10 and a printer 17.

The computer 10 functions as an image processing apparatus and forms information to be printed.

The printer 17 is a printing apparatus, that is, an output apparatus for receiving the information formed by the computer 10 and printing.

The computer 10 and the printer 17 are connected through a network or directly connected by a local port.

Application software 11 is a functional unit such as word processor, graphic processor, or the like installed in the host computer 10 and forms the information to be printed by the printer 17.

A printer driver 12 is a functional unit serving as a data converting unit and converts the data received from the application software 11 into a printer language which can be recognized by the printer 17.

A spooler 13 is a storage control unit for receiving the data converted by the printer driver 12 into a format which can be recognized by the printer 17 and storing the data into a storing device 14.

The storing device 14 is a storing unit constructed by, for example, a storing medium such as a hard disk or the like. The storing device 14 is not limited to a device built in the computer 10 but may be a device which is externally connected.

A reprint control apparatus 15 is a functional unit to monitor the spooler 13 and is an output control unit for instructing the spooler 13 and an output unit 16 to perform reprint. This functional unit has been installed in the computer 10 as a program that can be activated upon activation of an OS (Operating System).

The output unit 16 is a functional unit to transmit the print data received from the spooler 13 to the printer 17.

A display apparatus 18 is a display apparatus such as CRT, liquid crystal, or the like connected to the computer 10.

An input apparatus 19 is an input apparatus such as pointing device like a mouse or the like, keyboard, or the like connected to the computer 10.

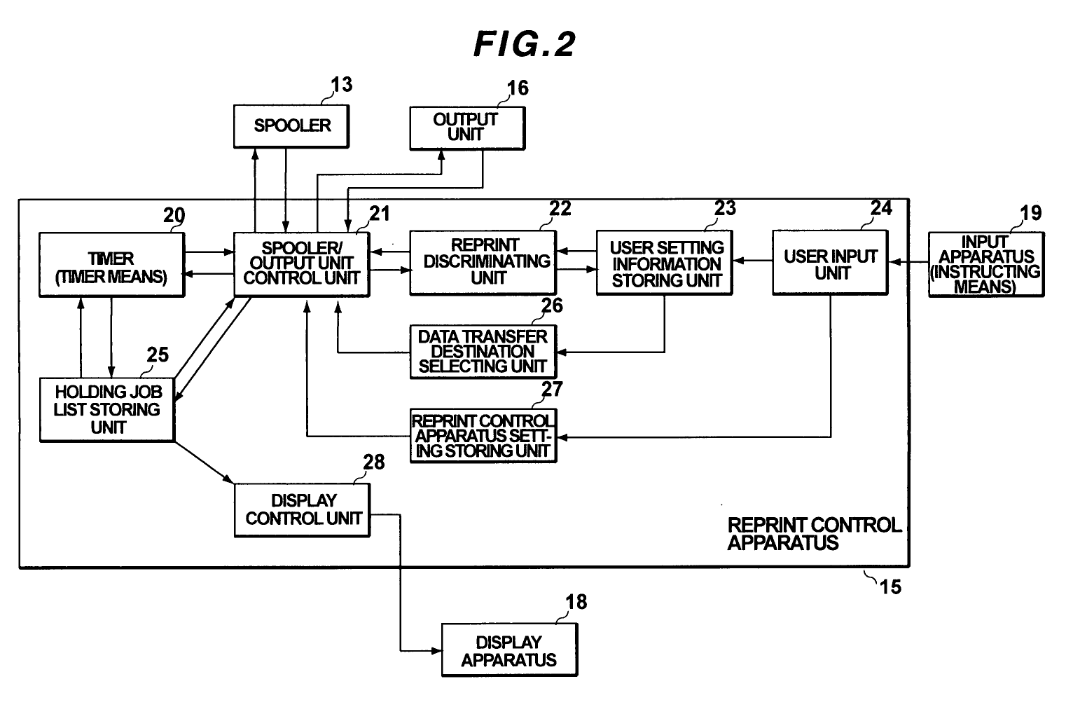

FIG. 2 is a block diagram showing a construction of a reprint control apparatus and is a block diagram showing a main section of the embodiment 1 of the invention. A reprint control apparatus 15 is shown.

In FIG. 2, the spooler 13, output unit 16, display apparatus 18, and input apparatus 19 are the same as those described above.

A timer 20 is a clock generator provided for the host computer 10 and is timer means for measuring a time to decide timing for detecting an operating state of the spooler 13 or timing for deleting the data stored in the storing device 14.

A spooler/output unit control unit 21 monitors whether or not the spooler 13 has received the print data from the printer driver 12, instructs the operation to store, delete, and reprint the print data, and designates an output destination of the output unit 16.

A reprint discriminating unit 22 discriminates whether or not a reprint request has been issued from the user with reference to a user setting information storing unit 23, thereby deciding whether or not the reprint is executed.

The user setting information storing unit 23 stores setting input information inputted through a user input unit 24 by using the input apparatus 19 by the user.

The user input unit 24 allows the display apparatus 18 to display a predetermined setting input display screen to the user and allows the user to input a reprinting instruction and a setting change instruction to the reprint control apparatus 15. The user inputs such instructions by the display screen. For example, the user executes the input operation by a GUI (Graphical User Interface).

A holding job list storing unit 25 stores a list of the stored or deleted print data into the storing device 14.

A data transfer destination selecting unit 26 selects an output destination of the print data in the reprint mode.

A reprint control apparatus setting storing unit 27 stores the setting information obtained by the user input unit 24 into the storing device 14.

A display control unit 28 makes display control of various display screens to the display apparatus 18, for example, display control of the contents stored in the holding job list storing unit 25.

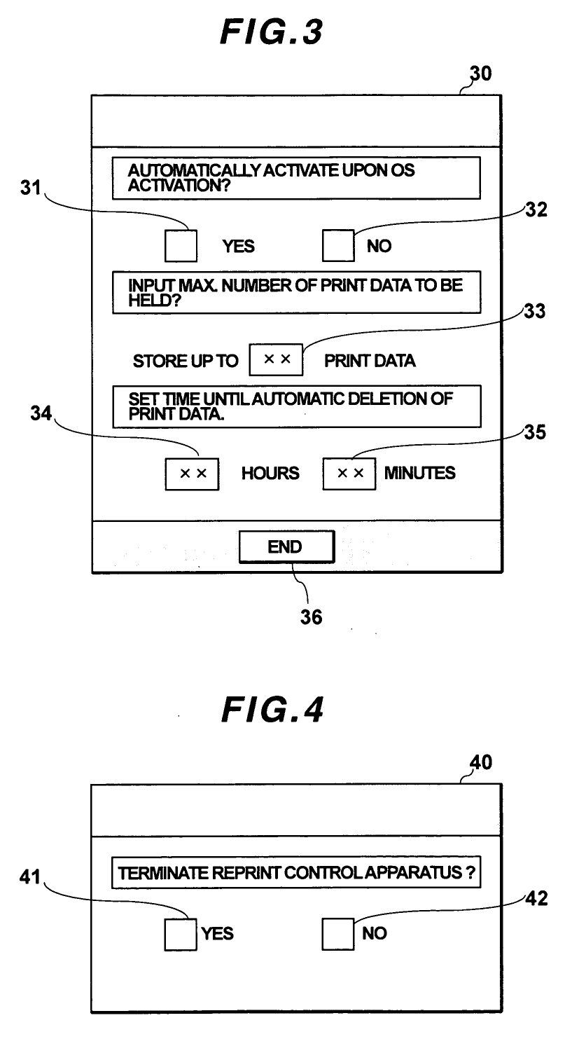

FIG. 3 is a diagram showing a construction of a reprint control apparatus setting display screen and shows the display screen for making the setting of the reprint control apparatus 15. This display screen is referred to as a reprint control apparatus setting display screen 30 hereinbelow. The reprint control apparatus setting display screen 30 is displayed by selecting the reprint control apparatus 15 by a menu bar of the OS.

As for the timing for activating the reprint control apparatus 15, whether or not the reprint control apparatus 15 is automatically activated upon activation of the OS is set by marking one of setting items 31 and 32. If the mode in which the reprint control apparatus 15 is not activated upon activation of the OS is set, the user can activate the reprint control apparatus 15 at arbitrary timing during the activation of the OS. The input operation of those settings is executed by operating the mouse or keyboard as an input apparatus of the computer 10.

Reference numeral 33 denotes an input item to designate the maximum number of print data to be stored. Reference numerals 34 and 35 denote input items to designate a holding time until the print data is automatically deleted.

In each of the input items 33, 34, and 35, the operator inputs a desired numerical value by the key input using the keyboard.

Reference numeral 36 denotes an end button. By operating this button, the operator finishes the reprint control apparatus setting display screen 30. When the operator presses the end button 36, the setting contents of the reprint control apparatus setting display screen 30 are stored into the storing device 14. The operator executes this operation by clicking the end button 36 by operating the mouse or the like.

FIG. 4 is a diagram showing a construction of a termination selecting display screen. A termination selecting display screen 40 in the case where “END” of the reprint control apparatus 15 is selected by the menu bar of the OS is displayed.

According to the termination selecting display screen 40 shown in FIG. 4, by clicking one of operation buttons 41 and 42 by using the mouse or the like, the operator can select whether or not the reprint control apparatus 15 is terminated.

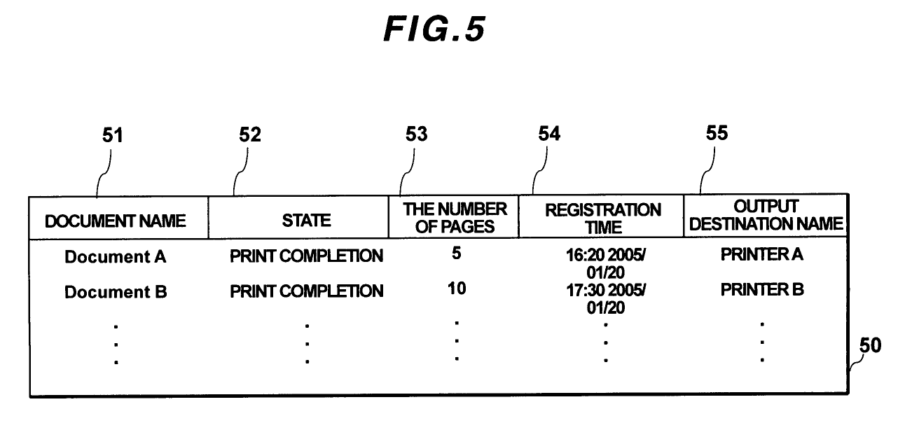

FIG. 5 is a diagram showing a construction of a holding job list and shows the contents in a holding job list 50 indicative of the state of the print data stored in the storing device 14.

The holding job list 50 shown in the diagram includes the following five kinds of items: a document name 51; a state 52; the number of pages 53; registration time 54; and an output destination name 55.

The document name 51 is identification (ID) information of each print data. The state 52 is information showing the state of each print data, that is, whether the printing has been completed. The number of pages 53 is information showing the number of pages of each print data. The registration time 54 shows the time when each print data has been registered. The output destination name 55 shows the name of the printer serving as an output destination.

The registration time 54 shows the contents of the clock of the computer 10 displayed at the time of the registration of each print data. Therefore, management information of each print data is sequentially stored so as to be arranged from the top in FIG. 5 in order of the registration time 54.

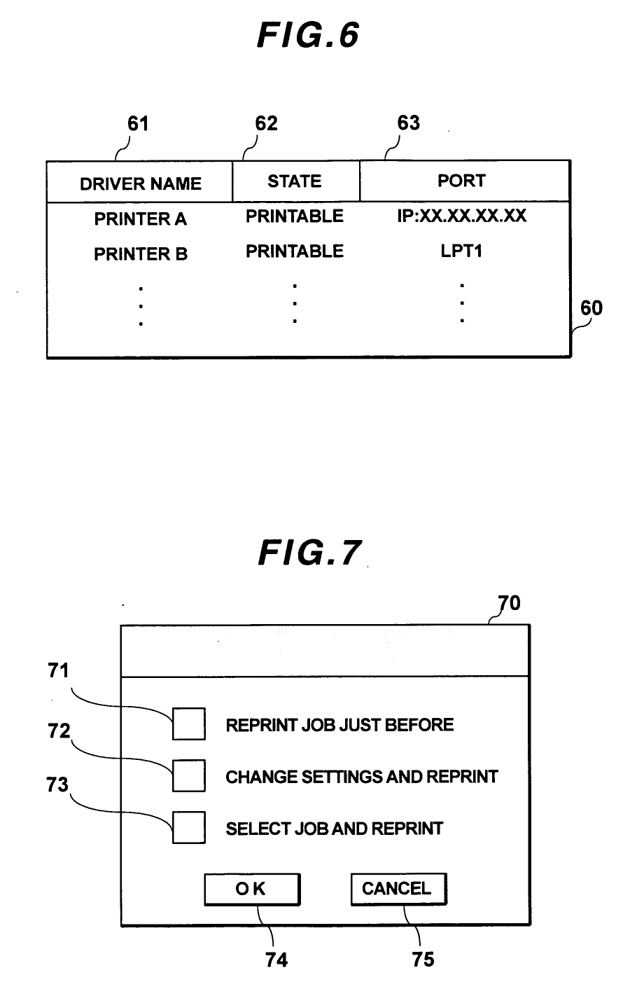

FIG. 6 is a diagram showing a construction of a printer driver list, that is, an information list of printer drivers installed in the computer 10. The printer driver 12 shown in FIG. 1 is also included in this information list. This information list is used to select the output destination in the reprint mode.

The list 60 includes information regarding a driver name 61, a state 62, and a port 63. The driver name 61 is displayed by the name of the printer which is driven. The state 62 displays information regarding whether or not the printing can be performed by using the corresponding printer. The port 63 shows the name of the port to output the print data.

FIG. 7 is a diagram showing a construction of a reprint selecting display screen. A reprint selecting display screen 70 as a display screen to select the type of reprint is shown. This reprint selecting display screen 70 is displayed after completion of the printing. This reprint selecting display screen 70 can be also displayed by using the menu bar of the OS by the user.

There are three kinds of selection items in the reprint selecting display screen 70. That is, a desired one of the following modes can be selected by marking one of operation buttons 71, 72, and 73: the mode in which the job just before is reprinted; the mode in which the settings of the job just before are changed and the reprint is executed; and the mode in which the job is selected and reprinted. The selecting operation is executed by clicking a desired button by operating the mouse or the like.

In FIG. 7, an OK button 74 is an operation button for validating the contents of the displayed selection and terminating the reprint selecting display screen 70. A cancel button 75 is an operation button for invalidating the contents of the displayed selection and terminating the reprint selecting display screen 70.

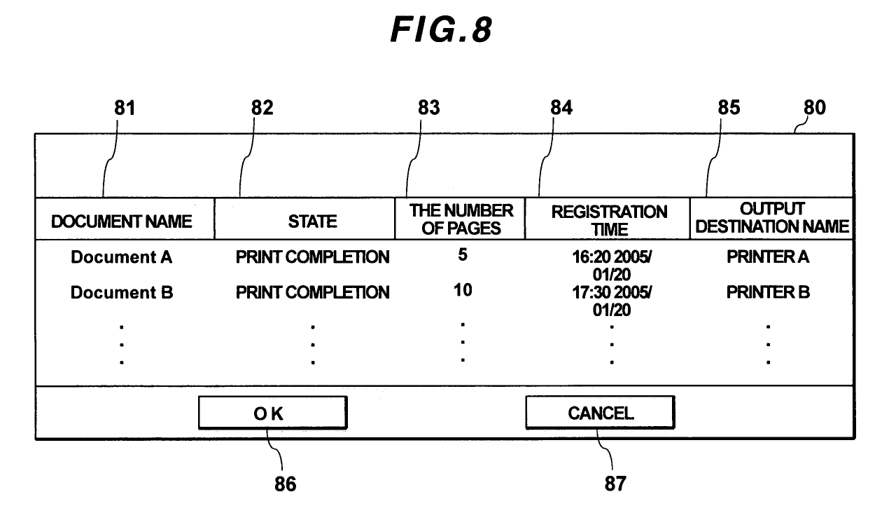

FIG. 8 is a diagram showing a construction of a job selection display screen. A job selection display screen 80 to select the job to be reprinted is shown. This job selection display screen 80 is displayed when the user has selected the job by the reprint selecting display screen 70, selected the execution of the reprint, and clicked the OK button 74.

The contents which are displayed on the job selection display screen 80 are substantially the same as those stored on the holding job list of FIG. 5 and include the following five kinds of items: a document name 81; a state 82; the number of pages 83; registration time 84; and an output destination name 85.

In FIG. 8, when the user clicks the document name 81 of one of the displayed rows by using the mouse or the like, the job of the relevant document name is selected. In FIG. 8, the row of the selected document name is displayed in a different color.

In the above case, a plurality of jobs can be also selected.

By clicking the document name of the same row, the display color of the relevant row is returned to the original color and the selection is cancelled.

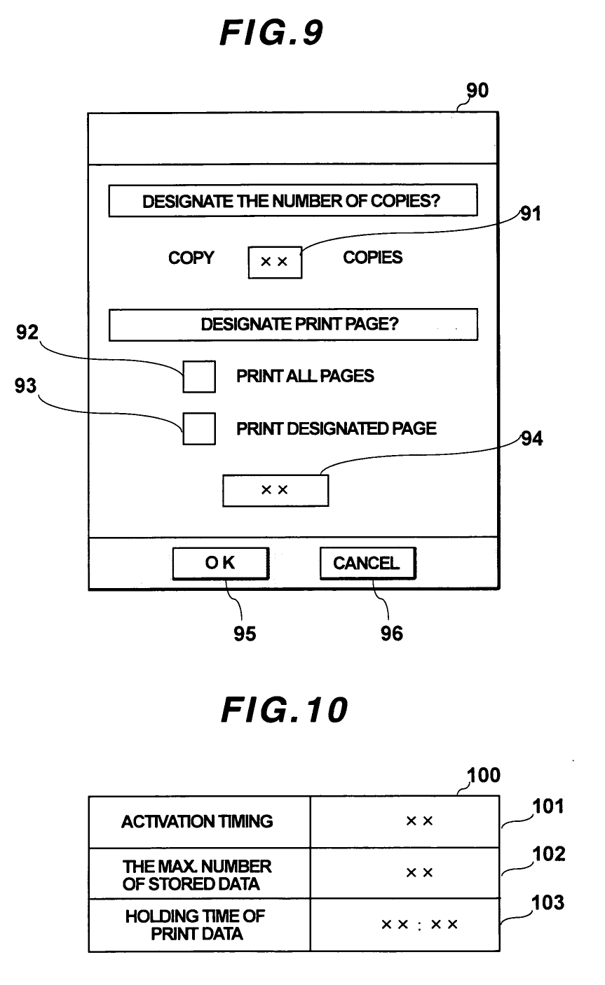

An OK button 86 is clicked to terminate the job selection display screen 80. By clicking the OK button, a setting change display screen 90 in FIG. 9 is displayed. A cancel button 87 is a button to terminate the job selection display screen 80 and return the display contents of the display screen to the reprint selecting display screen 70 of FIG. 7.

FIG. 9 is a diagram showing a construction of the setting change display screen. The setting change display screen 90 to change the print settings upon reprinting is shown.

The setting change display screen 90 is used to designate the number of print copies when the reprint is executed and designate the print page when partial printing is executed.

On the display screen shown in FIG. 9, the following items are displayed: a numeral input box 91; check boxes 92 and 93; a numeral input box 94; an OK button 95; and a cancel button 96.

The numeral input box 91 is used for the operator to input a numerical value by the keyboard when the number of print copies is designated. The check boxes 92 and 93 are used for the operator to select either the mode to print all pages or the mode to print the page designated by the operator by clicking one of those check boxes by using the mouse or the like.

The numeral input box 94 is used for the operator to input a numerical value of the designated page when he has selected the mode to print the designated page. The OK button 95 is used to terminate the setting change display screen 90 and execute the reprint in accordance with the setting contents set by each of the foregoing display screens.

The cancel button 96 is used to cancel the setting contents set by each of the foregoing display screens. By clicking this button, the display on the display screen is returned to the reprint selecting display screen 70.

FIG. 10 is a diagram showing a construction of a work area.

A work area 100 of FIG. 10 is formed in the storing device 14 and the setting values set by the reprint control apparatus setting display screen 30 are stored in the work area 100.

In FIG. 10, activation timing 101 is a setting value showing whether or not the reprint control apparatus is activated upon activation of the OS. The maximum number of stored data (102) is a setting value showing the maximum number of print data which is stored. A holding time 103 of the print data is a setting value showing a time until the print data is automatically deleted.

The operation of the embodiment 1 will now be described.

First, the operation which is executed until the spooler 13 obtains the image data, that is, the print data from the application software 11 through the printer driver 12 will be described with reference to FIG. 1.

The application software 11 sends the formed data to the printer driver 12 in order to print and output it. For example, in the case of word processor software, the application software 11 sends document data.

The printer driver 12 which received the document data to be printed and outputted from the application software 11 converts the document data into a printer language which can be recognized by the printer 17 and transmits the converted data to the spooler 13.

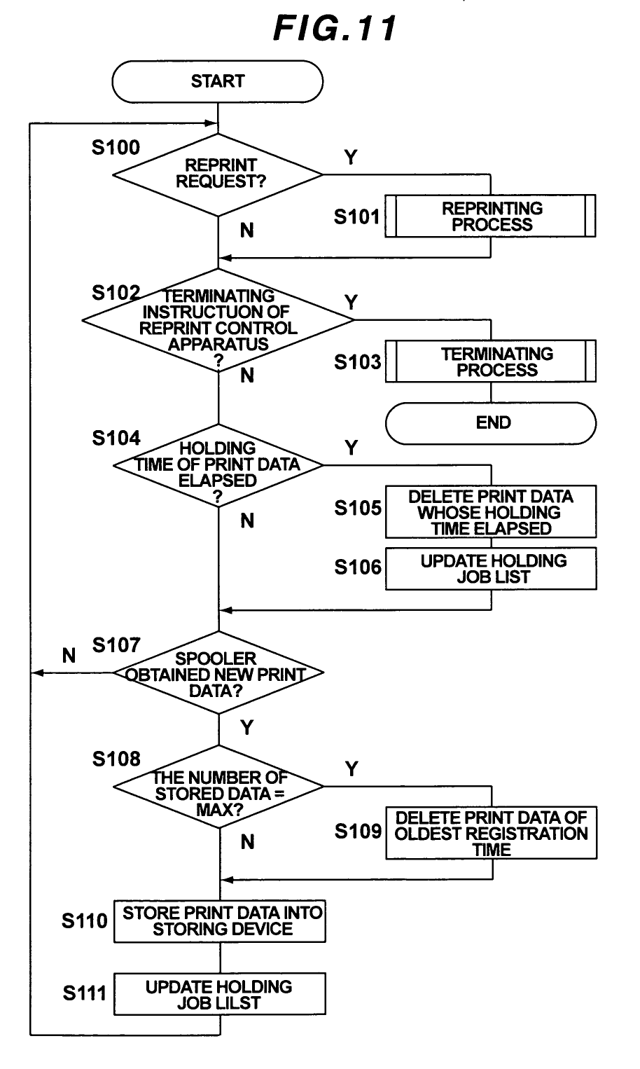

Processes which are executed after the spooler 13 received the data will now be described mainly with reference to a flowchart of FIG. 11.

FIG. 11 is the flowchart showing a main processing routine of the program which is executed as a reprint control apparatus 15.

First, in step S100, the reprint control apparatus 15 discriminates the presence or absence of the reprint request by using the reprint discriminating unit 22 with reference to the user setting information storing unit 23.

That is, in the reprint control apparatus 15, the spooler/output unit control unit 21 receives a notification indicative of the print completion from the output unit 16 and transfers the notification to the reprint discriminating unit 22. When the notification is received, the reprint discriminating unit 22 receives the reprinting instruction information and the setting information upon reprinting which were inputted through the user input unit 24 by the user from the user setting information storing unit 23 and decides whether or not the reprint is executed.

If a result of the discrimination is YES, a reprinting process is executed in step S101. The contents of the reprinting process will be explained hereinafter.

If the result of the discrimination of step S100 is NO, step S102 follows.

In step S102, whether or not a terminating instruction has been issued to the reprint control apparatus 15 is discriminated. The terminating instruction is made by a method whereby the operator allows the terminating display screen to be displayed by the menu bar of the OS and selects “END”.

If a result of the discrimination is YES, a terminating process is executed in step S103. The contents of the terminating process will be explained hereinafter.

If the result of the discrimination of step S102 is NO, step S104 follows.

In step S104, whether or not the holding time of the print data has elapsed is discriminated.

This discrimination is made by a method whereby the holding time 103 of the print data which has been set by “hours” and “minutes” in the input items 34 and 35 on the reprint control apparatus setting display screen 30 and has been stored in the storing device 14 is compared with the registration time 54 registered in the holding job list 50.

If the result of the discrimination is YES, step S105 follows.

If the result of the discrimination of step S104 is NO, step S107 follows.

In step S105, the print data whose holding time has elapsed is deleted from the storing device 14.

In step S106, the information of the print data deleted from the storing device 14 is deleted from the holding job list 50.

In step S107, whether or not the spooler 13 has obtained the new print data is discriminated. This discrimination is made by the spooler/output unit control unit 21. That is, the spooler/output unit control unit 21 monitors whether or not the spooler 13 has written the data into the storing device 14. When the spooler 13 has written the data, the spooler/output unit control unit 21 detects it and notifies the main processing routine that the data has been written.

If a result of the discrimination is YES, step S108 follows.

If the result of the discrimination of step S107 is NO, the processing routine is returned to step S100.

In step S108, whether or not the number of stored print data is equal to the maximum value MAX is discriminated.

This discrimination is made by a method whereby the maximum number of stored data (102) which has been set by the setting of the maximum value of the number of stored print data on the reprint control apparatus setting display screen 30 and has been stored in the storing device 14 is compared with the number of documents registered in the holding job list.

If a result of the discrimination is YES, step S109 follows.

If the result of the discrimination of step S108 is NO, step S110 follows.

In step S109, the print data of the oldest registration time 54 is searched from the holding job list 50 and deleted from the storing device 14.

In step S110, the new print data is stored into the storing device 14.

In step S111, information regarding the new print data is added to the holding job list 50 and, thereafter, the processing routine is returned to step S100.

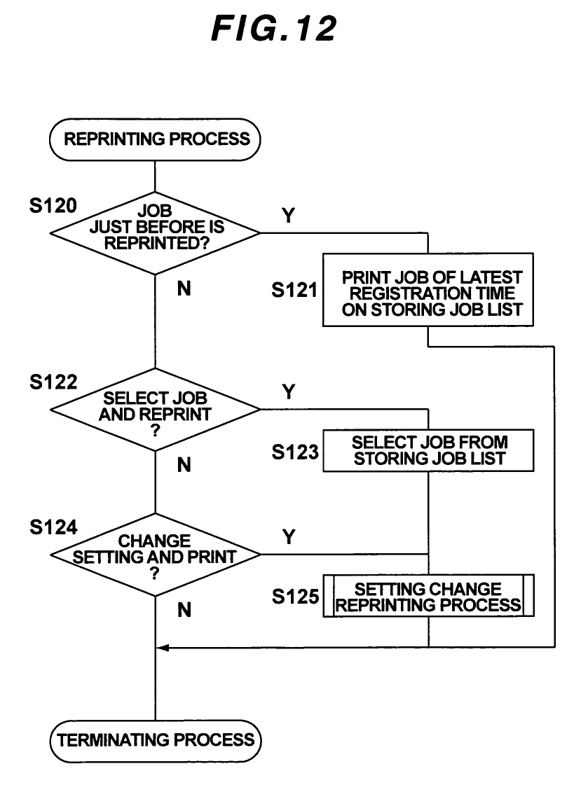

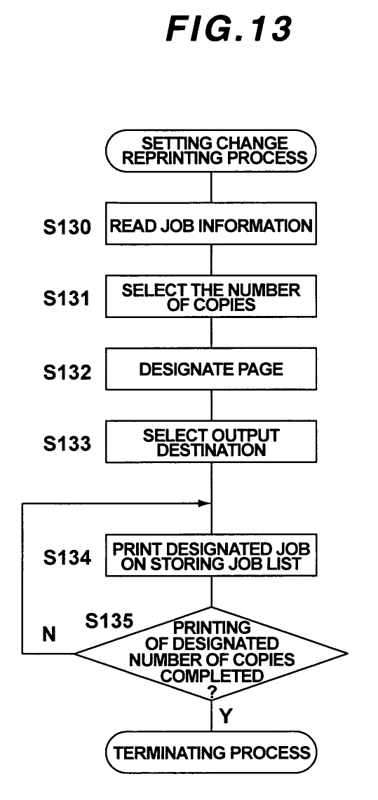

The reprinting process will now be described with reference to flowcharts of FIGS. 12 and 13.

FIG. 12 is the flowchart showing the reprinting process.

In step S120, whether or not the print data of the job which has been printed just before the present job is reprinted is discriminated. The job just before indicates the job whose registration time 54 is the latest time in the holding job list 50.

If a result of the discrimination is YES, step S121 follows.

In step S121, the print data whose registration time 54 is the latest time in the holding job list 50 is reprinted and the reprinting process is terminated.

If the result of the discrimination of step S120 is NO, step S122 follows.

In step S122, whether or not the reprint is executed in accordance with the job selected by the user is discriminated.

If a result of the discrimination is YES, step S123 follows.

In step S123, the user is allowed to select the desired job from the holding job list 50. Then, step S125 follows.

If the result of the discrimination of step S122 is NO, step S124 follows.

In step S124, whether or not the print settings are changed and the reprint is executed is discriminated.

If a result of the discrimination is YES, step S125 follows.

In step S125, a setting change reprinting process is executed.

FIG. 13 is the flowchart for explaining the setting change reprinting process.

The setting change reprinting process will be described hereinbelow with reference to FIG. 13.

In step S130, information of the job selected from the holding job list 50 is read.

In step S131, information of the numerical value indicative of the number of prints (the number of copies) is read.

In step S132, page designation information is read.

In step S133, the driver is selected on the basis of the driver names on the output destination list.

In step S134, the print data of the job is printed in accordance with the contents of the information read out in steps S131, S132, and S133. This printing is executed by a method whereby the spooler/output unit control unit 21 issues a printing instruction to the spooler 13, the spooler 13 transfers the print data from the storing device 14 to the output unit 16, and the output unit 16 transmits the print data to the printer.

In step S135, whether or not the print data of the designated number of print copies has been transmitted is discriminated.

If a result of the discrimination is YES, the processing routine is finished.

If the result of the discrimination is NO, the processing routine is returned to step S134.

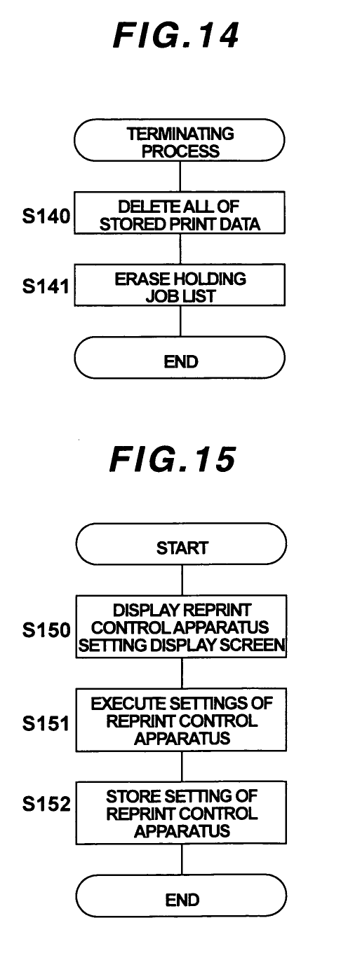

The terminating process will now be described with reference to a flowchart of FIG. 14. This process is activated by the OS when the operator selects the termination of the reprint control process by using the termination selecting display screen of FIG. 4 which is displayed through the operation of the OS menu bar.

In step S140, all of the print data held in the storing device 14 are deleted.

In step S141, the holding job list 50 of FIG. 5 is erased and the terminating process is finished.

The setting of the reprint control apparatus 15 will now be described with reference to FIG. 15. This process is activated by the OS when the operator operates the OS menu bar.

In step S150, the reprint control apparatus setting display screen of FIG. 3 is displayed.

In step S151, the setting of the reprint control apparatus 15 is executed by the operator's operation in accordance with the reprint control apparatus setting display screen of FIG. 3.

That is, whether or not the reprint control apparatus 15 is automatically activated upon OS activation is selected. The maximum number of print data which can be stored is set. The time until the stored print data is automatically deleted is set. By clicking the end button by using the mouse or the like, the reprint control apparatus setting display screen of FIG. 3 is finished.

In step S152, the information set by the above setting operation by clicking the end button is stored in the storing device 14 and the setting process is finished.

As mentioned above, according to the embodiment 1, the reprint control apparatus is provided and the print data upon printing is stored and managed. Therefore, the reprint control apparatus is activated and the reprint can be executed irrespective of whether or not the reprint has been designated in the application software.

### Embodiment 2

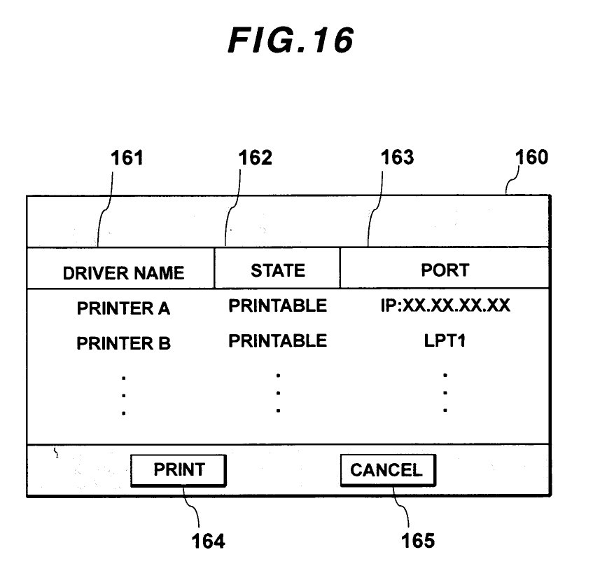

According to the embodiment 2, an output destination selecting display screen 160 as shown in FIG. 16 is displayed so as to enable the operator to select the printer as an output destination of the print data in the apparatus of the embodiment 1. The output destination selecting display screen 160 is displayed by clicking the OK button 95 in the setting change display screen 90 shown in FIG. 9.

Items which are displayed on the setting change display screen 160, that is, a driver name 161, a state 162, and a port 163 have the contents registered in a printer driver list 60 shown in FIG. 6 mentioned above.

In the setting change display screen 160, by clicking the driver name 161 of an arbitrary row by using the mouse or the like, the display color of such a row is changed and the driver shown in this display color is selected. By clicking again the driver name 161 of the same row by the mouse or the like, the display color of such a row is returned to the original color and the selection of the driver is cancelled.

By clicking a print button 164, the reprint is executed by the driver selected on the output destination selecting display screen 160 in accordance with the display contents set in each of the foregoing display screens.

By clicking a cancel button 165, the display of the output destination selecting display screen 160 is finished and returned to the display of the reprint selecting display screen 70 in FIG. 7.

The operation of the embodiment 2 will now be described with reference to FIGS. 6, 16, and 13 used in the above explanation.

The information regarding the printer drivers installed in the computer 10 has been stored in the printer driver list 60 of FIG. 6 described in the embodiment 1.

In step S133 in FIG. 13, the output destination to which the print data has been outputted just before is selected in the embodiment 1. However, in the embodiment 2, by providing the output destination selecting display screen of FIG. 16, a desired printer driver is selected from the printer driver list 60. In this instance, if the output destination is not changed, the operator does not need to execute any operation.

In other words, the output destination to which the print data was outputted just before has been selected in a default state. Therefore, in the default state, the print data to be outputted is outputted to the same printer as that just before in a manner similar to the case in the embodiment 1. Consequently, it is sufficient that the operator merely clicks the print button.

On the other hand, in the case where print quality in the printer which has previously printed is poor or the case of the absence of toner, the absence of paper, a failure of a mechanism, or the like, if the same printer as that used just before is used, it takes a time for countermeasure upon reprinting. In such a situation, when the output destination selecting display screen is displayed, the operator arbitrarily selects the output destination which can execute the proper printing and in which the preparation has been completed and can execute the printing.

As mentioned above, according to the embodiment 2, since the operator can arbitrarily change the output destination to the desired printer, even if a failure occurred in the printer which has printed just before, another printer can be used and the time and troublesomeness which are required until the completion of the reprint can be omitted.

By sequentially changing the output destinations, a trial printing of each printer can be also executed.

Although the case of setting the printer as an output destination has been described above in each of the foregoing embodiments, the invention is not limited to such an example but can be also applied to the case where an MFP, a copying apparatus, an image recording apparatus are set as output destinations.

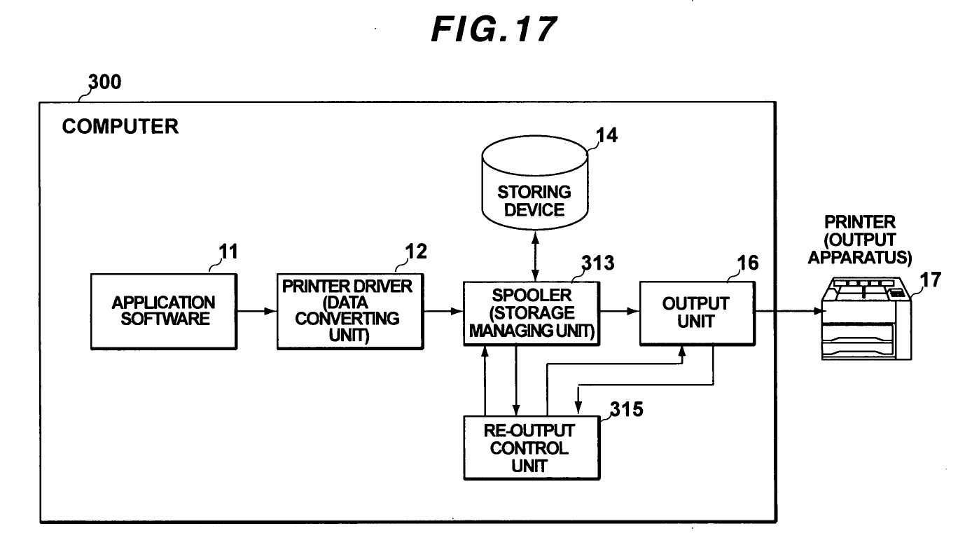

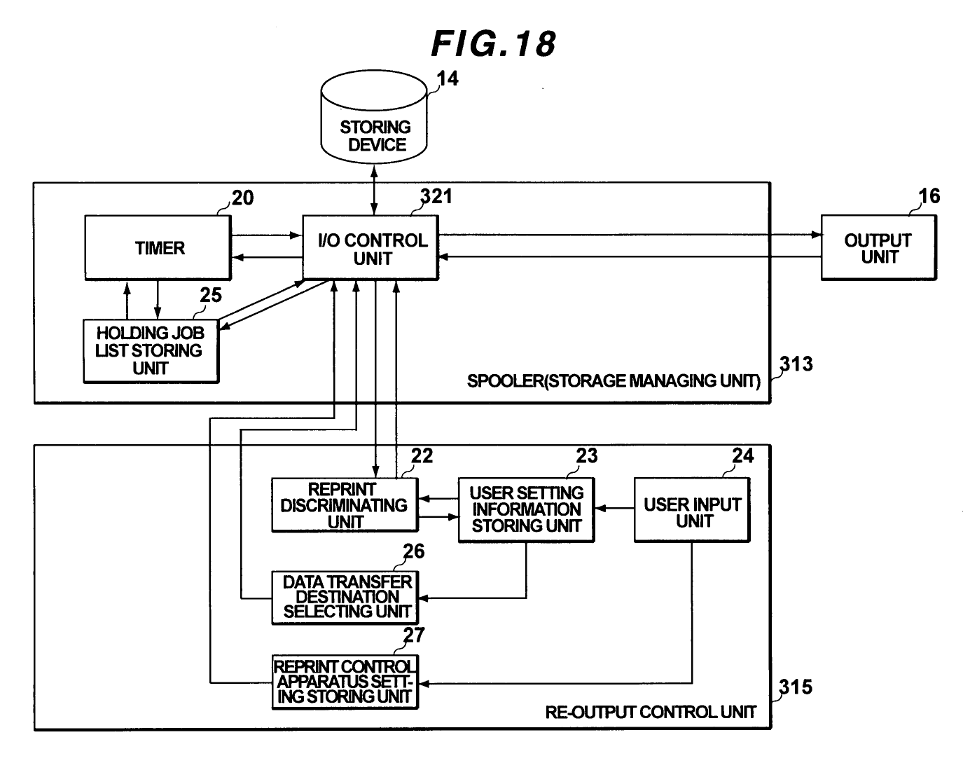

The construction of the image processing apparatus and the reprint control apparatus according to the invention are not limited to those in the case shown in FIGS. 1 and 2 but a layout and a construction of each functional unit may be properly changed. For example, they can be also constructed as shown in FIGS. 17 and 18.

FIGS. 17 and 18 are block diagrams showing modifications of the image processing apparatus and the reprint control apparatus according to the invention. In a computer 300 with the construction of FIG. 17, a functional unit for making the storage management of the print data stored in the storing device 14 as print data for reprint is provided for a spooler 313 and other functional units are provided for a re-output control unit 315.

As shown in FIG. 18, the input and output to/from the storing device 14 and the output unit 16 are controlled by an input/output (I/O) control unit 321 of the spooler 313. The I/O control unit 321 stores and manages the print data for reprint, reads out the print data from the storing device 14 in accordance with an instruction from the re-output control unit upon reprinting, and sends it to the output unit 16. Other constructions are substantially the same as those in FIGS. 1 and 2 and, in FIGS. 17 and 18, the same functional units as those in FIGS. 1 and 2 are designated by the same reference numerals.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
a data converting unit which converts inputted image information into image data which can be outputted by an output apparatus connected to an outside;
an output control unit which outputs the image data converted by said data converting unit to the output apparatus;
a storing unit which sequentially stores the image data in parallel with the output of the image data from said data converting unit to said output control unit; and
an instructing means which selects a desired one of the plurality of image data which have sequentially been stored in said storing unit and instructs said output control unit to re-output the selected image data,
wherein said output control unit, when is instructed to re-output by said instructing means, transfers the image data selected by said instructing means to said output apparatus from said storing unit.

2. The image processing apparatus according to claim 1, further comprising an image information forming unit which forms said image information,
and wherein said data converting unit converts the image information formed by said image information forming unit.

3. The image processing apparatus according to claim 1, further comprising an image reading unit which reads said image information from a sheet of original,
and wherein said data converting unit converts the image information read by said image reading unit.

4. The image processing apparatus according to claim 1, further comprising a communicating unit which receives said image information from an external transmitting apparatus,
and wherein said data converting unit converts the image information received by said communicating unit.

5. The image processing apparatus according to claim 1, further comprising:
timer means which measures a holding time of the image data stored in said storing unit; and
deleting means which deletes the image data stored in said storing unit,
and wherein said storing unit stores the image data which is sequentially stored and time information indicative of time when said image data has been stored in correspondence to each other, and
when the holding time measured by said timer means exceeds a predetermined period, said deleting means deletes the corresponding image data from said storing unit.

6. The image processing apparatus according to claim 5, further comprising counter means which counts the number of image data stored in said storing unit,
and wherein when the number of image data counted by said counter means exceeds a predetermined number, said deleting means deletes the image data from said storing unit.

7. The image processing apparatus according to claim 6, wherein said deleting means deletes the image data in order from the image data of a longer holding period.

8. The image processing apparatus according to claim 1, wherein said output control unit further has:
a holding job list storing unit which stores identification information of the image data stored in said storing unit and said image data in correspondence to each other;
a display control unit which displays the identification information stored in said holding job list storing unit to a display apparatus; and
a user input unit which selects a job to be re-outputted on the basis of the identification information displayed on said display apparatus.

9. The image processing apparatus according to claim 1, further comprising a data transfer destination selecting unit which selects an output destination of said image data.
